(19) United States
(12) Patent Application Publication
(10) Pub. No.: US 2004/0078981 A1
(43) Pub. Date: Apr. 29, 2004

(54) Foldable knife having a single blade

(75) Inventor: Yang-Fu Cheng, Taipei (TW)

Correspondence Address: BACON & THOMAS, PLLC, 625 SLATERS LANE, FOURTH FLOOR, ALEXANDRIA, VA, 22314

(73) Assignee: KANTAS PRODUCTS CO., LTD., Taipei (TW)

(21) Appl. No.: 10/277,816

(22) Filed: Oct. 23, 2002

(51) Int. Cl. B26B 1/02

(52) U.S. Cl. 30/161; 30/155

(57) ABSTRACT

The invention relates a foldable knife comprising a flat handle with a blade pivotably coupled to a forward end thereof; a central first opening through the handle; a resilient piece in the first opening extended from a distal end of the handle to a proximate end about the blade and having an upward slightly curved stop at an open end to lock the blade in the opened position; a second opening adjacent the first opening; and a gap disposed at an edge of the handle in communication with both the second opening and the outside. The gap can be pulled to be wide enough to allow an object (e.g., belt loop of pants) to pass through into the second opening for attaching the knife to a user.

### FIELD OF THE INVENTION

The present invention relates to foldable knifes and more particularly to a foldable knife having a single blade with improved characteristics such as the blade being protected in a closed position and the knife being attachable to a belt loop of pants worn on a person.

### BACKGROUND OF THE INVENTION

A conventional foldable knife having a single blade is shown in FIG. 1. The knife 10 comprises a flat handle 11, a blade 13 pivotably coupled to a forward end of the handle 11 so that the blade 13 is rotatable either into the handle 11 in a closed position or out of the handle 11 in an opened position, a central opening 15 through the handle 11, and a resilient piece 16 in the opening 15 extended from a distal position to a proximate position about the blade 13, the resilient piece 16 having an upward slightly curved stop 161 at an open end. In rotating the blade 13 out of the handle 11, such rotation is continued until a rear end 131 of the blade 13 contacts the stop 161. At this time, the blade 13 is locked in the opened position. Conversely, a user may press the resilient piece 16 to disengage the stop 161 from the rear end 131 of the blade 13. Next, the user may rotate the blade 13 into the handle 11 to its closed position.

However, the prior art knife suffered from a disadvantage. For example, the knife is not allowed to attach to a belt loop of pants worn on a person. This may cause inconvenience while carrying the knife. Thus, it is desirable to provide a foldable knife having a single blade, the knife being attachable to a belt loop of pants worn on a person.

### SUMMARY OF THE INVENTION

A primary object of the present invention is to provide a foldable knife comprising a flat handle; a blade pivotably coupled to a forward end of the handle so that the blade is rotatable either into the handle in a closed position or out of the handle in a opened position; a central first opening through the handle; a resilient piece in the first opening extended from a distal position to a proximate position about the blade, the resilient piece having an upward slightly curved stop at an open end wherein in rotating the blade out of the handle, the rotation is continued until a rear end of the blade contacts the stop so as to lock the blade in the opened position; a second opening adjacent the first opening; and a gap disposed at an edge of the handle in communication with both the second opening and the outside. The gap can be pulled to be wide enough to allow an object (e.g., belt loop of pants) to pass through into the second opening for attaching the knife to a user while going out. By utilizing this foldable knife, it is possible of overcoming the above drawback (i.e., the knife is not allowed to be attached to the belt loop of the pants worn on the user) of the prior art.

Another object of the present invention is to provide a foldable knife having a single blade. The knife further comprises an elongated, curved protective element formed along an edge of the handle. The protective element has a predetermined height sufficient to prevent a cutting edge of the blade from contacting the hand of the user when the blade is in the closed position. Also, the blade itself is prevented from being damaged by other objects as protected by the protective element.

The above and other objects, features and advantages of the present invention will become apparent from the following detailed description taken with the accompanying drawings.

### BRIEF DESCRIPTION OF THE DRAWINGS

FIG. 1 is a perspective view of a conventional foldable knife having a single blade;

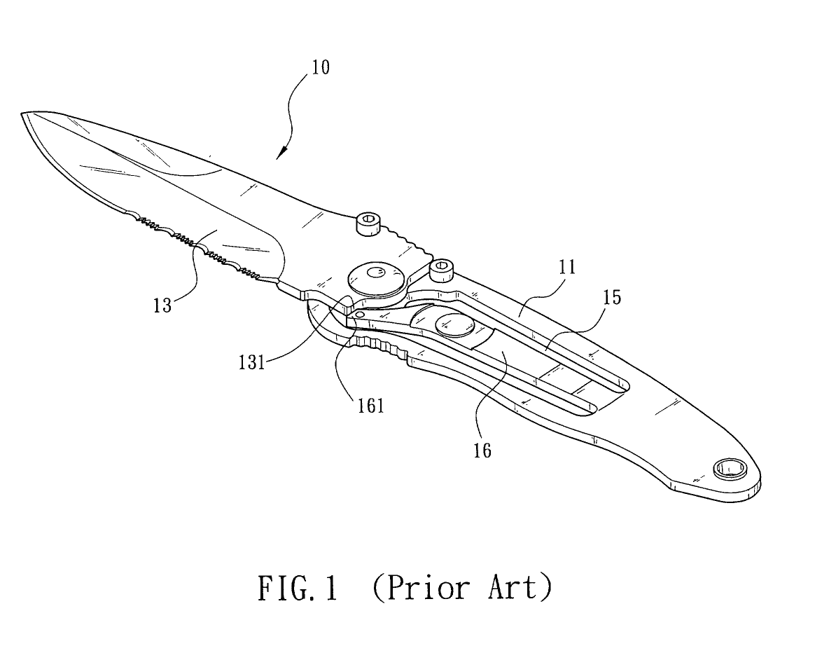

FIG. 2 is a perspective view of a first preferred embodiment of a foldable knife having a single blade according to the invention, showing the blade of the knife in its opened position;

FIG. 3 is a view similar to FIG. 2, showing the blade of the knife in its closed position;

FIG. 4 is an environmental view where the knife is attached to a belt loop of pants;

FIG. 5 is a perspective view of a second preferred embodiment of a foldable knife having a single blade according to the invention, showing the blade of the knife in its closed position; and

FIG. 6 is a perspective view of a third preferred embodiment of a foldable knife having a single blade according to the invention, showing the blade of the knife in its closed position.

### DETAILED DESCRIPTION OF THE PREFERRED EMBODIMENTS

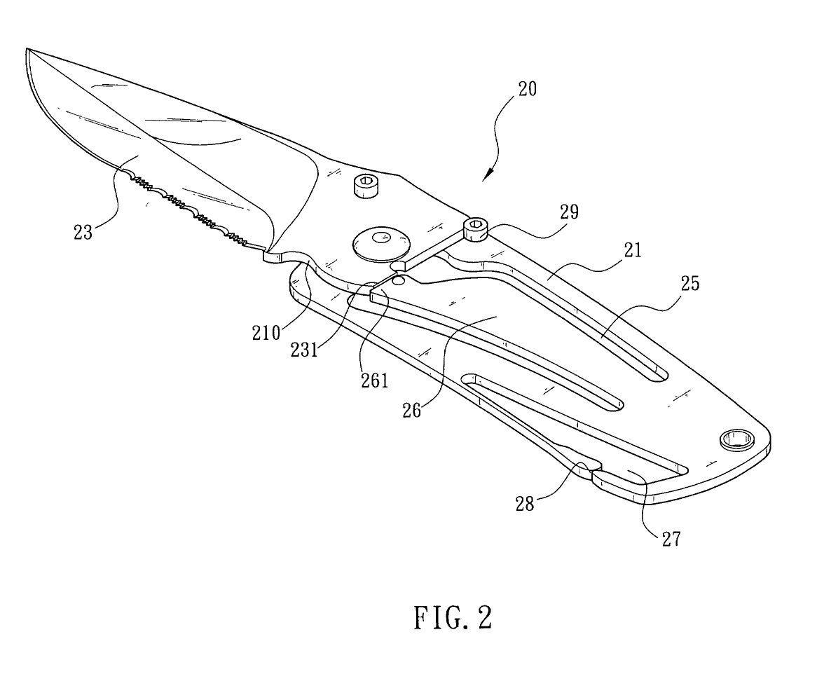

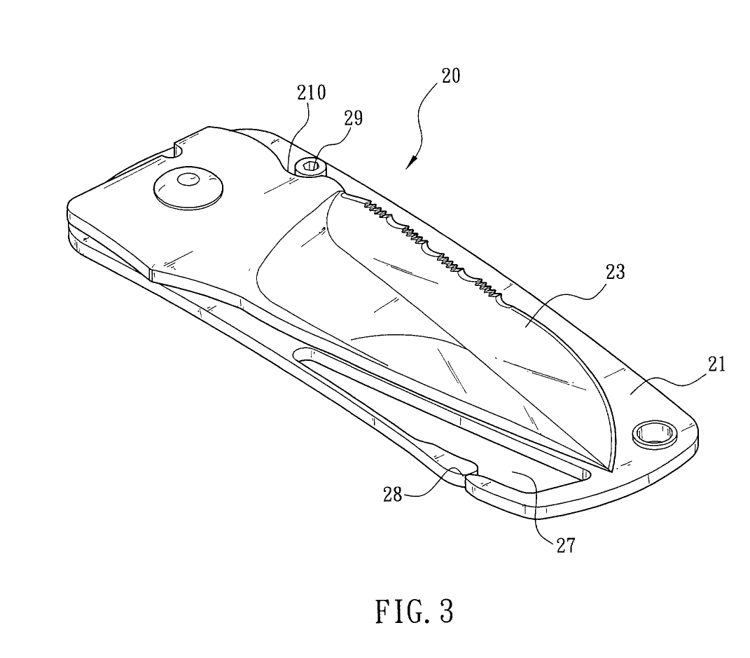

The invention is directed to an improved foldable knife having a single blade in order to overcome the above drawback of the prior art. Referring to FIGS. 2 and 3, the foldable knife 20 comprises a flat handle 21, a blade 23 pivotably coupled to a forward end of the handle 21 so that the blade 23 is rotatable either into the handle 21 in a closed position or out of the handle 21 in a opened position, the blade 23 having a planar surface on one side and a cutting edge on the other side, a central opening 25 through the handle 21, and a resilient piece 26 in the opening 25 extended from a distal position to a proximate position about the blade 23, the resilient piece 26 having an upward slightly curved stop 261 at an open end. In rotating the blade 23 out of the handle 21, such rotation is continued until a rear end 231 of the blade 23 contacts the stop 261. At this time, the blade 23 is locked in the opened position. Conversely, a user may press the resilient piece 26 to disengage the stop 261 from the rear end 231 of the blade 23. Next, the user may rotate the blade 23 into the handle 21 to its closed position.

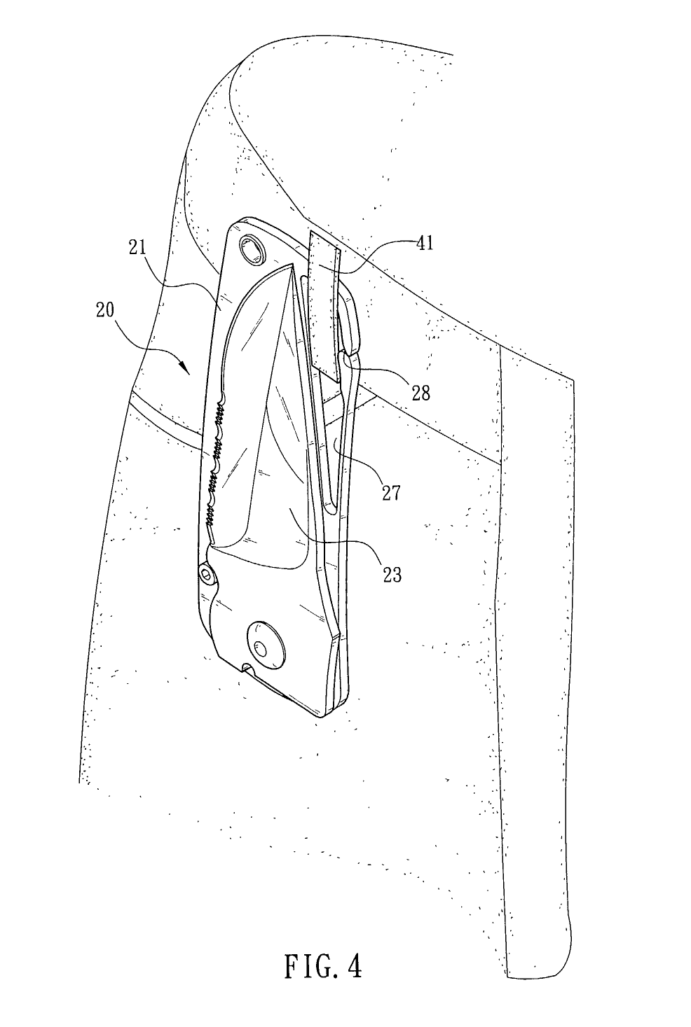

Referring to FIGS. 2 and 3 again, there are further provided a second opening 27 adjacent the opening 25 and a gap 28 at an edge of the handle 21 in communication with both the second opening 27 and the outside. Referring to FIG. 4, in a use state, a user can pull the gap 28 to be wide enough to allow an object (e.g., belt loop of pants) 41 to pass through into the second opening 27. Once the pulling force is released, the knife 20 is attached to the pants. Hence, the user can conveniently carry the knife 20 while going out.

Referring to FIG. 3 specifically, in the invention the user may alternatively pass a key ring through the widened gap 28 into the second opening 27. Again, once the pulling force is released, the knife 20 is attached to the key ring. Hence, the user can conveniently carry the knife 20 and the key ring together while going out.

Referring to FIGS. 2 and 3 again, in the invention there is further provided a front protrusion 29 on the handle 21 near an edge. Correspondingly, a curved part 210 is formed on a side of a tang portion of the blade 23. The protrusion 29 is engaged with the curved part 210 of the blade 23 when the blade 23 is rotated into the handle 21 to its closed position.

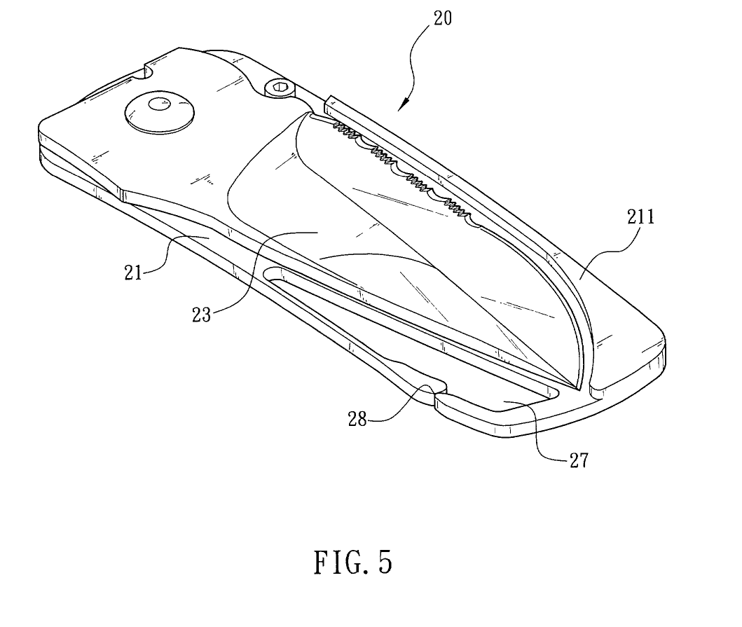

Referring to FIG. 5, there is shown a second preferred embodiment of the invention. In the preferred embodiment, an elongated, curved protective element 211 is formed along an edge of the handle 21. The protective element 211 has a height sufficient to prevent the cutting edge of the blade 23 from contacting a foreign object (e.g., the hand of the user) when the blade 23 is in its closed position. Such safe device (e.g., the protective element 211) protects the user's hand while holding, taking, or carrying the knife 20. Further, other objects can also be protected when they are stored together with the knife 20. Furthermore, with the provision of the protective element 211, the blade 23 itself can be prevented from being damaged by other objects.

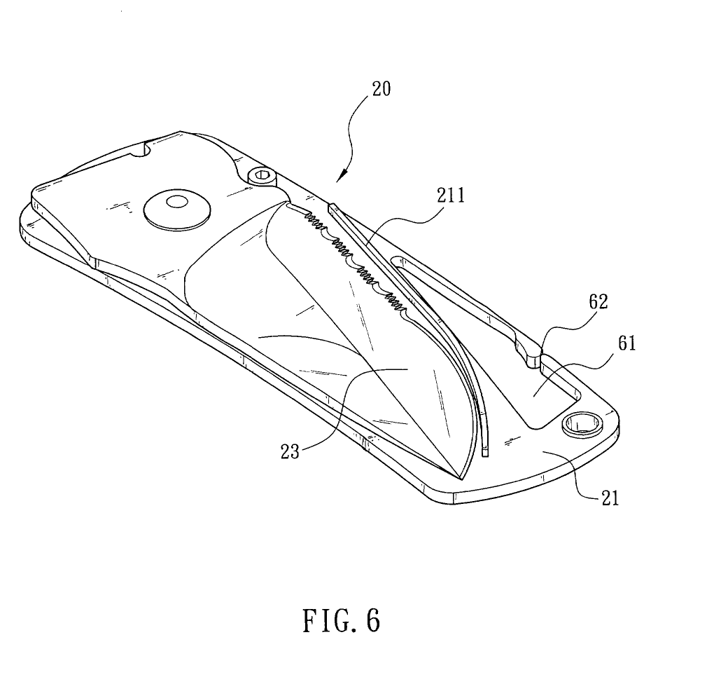

Referring to FIG. 6, there is shown a third preferred embodiment of the invention. In the preferred embodiment, an elongated, curved protective element 211 is formed on the handle 21. The protective element 211 has a height sufficient to prevent the cutting edge of the blade 23 from contacting a foreign object (e.g., the hand of the user) when the blade 23 is in its closed position. In other words, the protective element 211 is a safe device. Furthermore, a third opening 61 is formed on the handle 21 adjacent the protective element 211. The protective element 211 has a gap 62 at an edge of the handle 21 in communication with both the third opening 61 and the outside. Similar to the first preferred embodiment, in a use state, a user can pull the gap 62 to be wide enough to allow an object (e.g., belt loop of pants) to pass through into the third opening 61. Once the pulling force is released, the knife 20 is attached to the pants. Hence, the user can conveniently carry the knife 20 while going out.

While the invention has been described by means of specific embodiments, numerous modifications and variations could be made thereto by those skilled in the art without departing from the scope and spirit of the invention set forth in the claims.

What is claimed is:

1. A foldable knife comprising:
a handle;
a blade pivotably coupled to a forward end of the handle so that the blade is rotatable either into the handle in a closed position or out of the handle in a opened position;
a central first opening through the handle;
a resilient piece in the first opening extended from a distal position to a proximate position about the blade, the resilient piece having an upward slightly curved stop at an open end wherein in rotating the blade out of the handle, the rotation is continued until a rear end of the blade contacts the stop so as to lock the blade in the opened position;
a second opening adjacent the first opening; and
a gap disposed at an edge of the handle in communication with both the second opening and the outside,
wherein the gap is capable of being pulled to be wide enough to allow an object to pass through into the second opening for attaching the knife to a user.

2. The foldable knife of claim 1, wherein the object is a belt loop of pants.

3. The foldable knife of claim 1, further comprising a front protrusion disposed on the handle and a corresponding curved part disposed on a side of a tang portion of the blade wherein the protrusion is engaged with the curved part of the blade when the blade is rotated into the handle to the closed position.

4. The foldable knife of claim 1, further comprising an elongated, curved protective element formed along an edge of the handle, the protective element having a predetermined height sufficient to prevent a cutting edge of the blade from contacting the hand of the user when the blade is in the closed position and the blade itself is prevented from being damaged by other objects as protected by the protective element.
